(19) United States
(12) Patent Application Publication
(10) Pub. No.: US 2013/0000998 A1
(43) Pub. Date: Jan. 3, 2013

(54) Viscous Fan Drive for an Engine Cooling System

(75) Inventors: Steven P. Trower, Peoria, IL (US); William C. Morris, Peoria, IL (US); Sudhakar Lakshminarayanan, Peoria, IL (US); Rishabh Sinha, Peoria, IL (US); Dongming Tan, Peoria, IL (US)

(73) Assignee: CATERPILLAR, INC., Peoria, IL (US)

(21) Appl. No.: 13/173,055

(22) Filed: Jun. 30, 2011

(51) Int. Cl. F16D 33/06; B60K 11/00

(52) U.S. Cl. 180/68.1; 192/58.4

(57) ABSTRACT

A viscous fan drive for an engine cooling system has an output coupling defining a fluid operating chamber, an input coupling disposed in the fluid operating chamber, and a driveshaft coupled to the input coupling and defining a driveshaft axis. A main bearing has an inner race coupled to the driveshaft and an outer race coupled to the output coupling, the main bearing defining a bearing axis, wherein the bearing axis is normally substantially coincident with the driveshaft axis. A brace is disposed between the outer race of the main bearing and the output coupling. The engine cooling system may be provided on a machine having a rotatable frame that promotes precession of the output coupling, wherein the brace prevents movement of the main bearing along the driveshaft in response to the output coupling precession.

### TECHNICAL FIELD

The present disclosure generally relates to engine cooling systems, and more particularly to fan drives used in such systems.

### BACKGROUND

Many types of machines and vehicles have a cooling system that uses a viscous fan drive to operate an engine cooling fan. The viscous fan drive typically includes an input coupling assembly that is mechanically coupled to the engine to provide an input torque. The viscous fan drive also includes an output coupling assembly that provides an output torque to an output device, such as a fan. The viscous drive uses a viscous fluid to transfer a portion of the input torque of the input coupling assembly to the output coupling assembly, thereby to generate the output torque.

More specifically, the input coupling assembly includes a clutch plate that is coupled to a driveshaft. The driveshaft may be coupled directly to the engine crankshaft or indirectly to the crankshaft with a belt and pulley system. The output coupling assembly typically includes a body and a cover that are joined together to define a fluid chamber. The fluid chamber may include a fluid operating chamber, in which the clutch plate is disposed, and a fluid reservoir chamber. A main bearing is provided with an inner race coupled to the input coupling assembly and an outer race coupled to the output coupling assembly to permit relative rotation between the two.

The output torque generated by the viscous drive is a function of the rotational speed of the clutch and the amount of viscous fluid in the operating chamber. Specifically, an increase in clutch speed or fluid quantity will increase output torque, while a decrease in clutch speed or fluid quantity will decrease output torque. Changes in forces generated during operation of the fan drive, however, make conventional viscous drives overly susceptible to the effects of clutch plate precession. For example, U.S. Pat. No. 4,602,876 to Miki et al. discloses a mounting device for a bearing having an outer race formed with a groove. The groove includes an opening communicating with a bearing interior. A c-shaped fixing means engages the groove. As best shown in FIG. 2 of the '876 patent, the groove in the outer race is significantly deeper than a height of the fixing means. Furthermore, the fixing means includes a hooked end extending inwardly from the outer race and into the bearing interior. Accordingly, the Miki et al. device is overly complex and difficult to assembly, and does not adequately address the effects of clutch plate precession.

### SUMMARY OF THE DISCLOSURE

According to certain aspects of this disclosure, a viscous fan drive is provided for an engine cooling system having an output coupling defining a fluid operating chamber, an input coupling disposed in the fluid operating chamber, and a driveshaft coupled to the input coupling and defining a driveshaft axis. A main bearing has an inner race coupled to the driveshaft and an outer race coupled to the output coupling, the main bearing defining a bearing axis, wherein the bearing axis is normally substantially coincident with the driveshaft axis. A brace is disposed between the outer race of the main bearing and the output coupling.

In another aspect of the disclosure that may be combined with any of these aspects, the output coupling may include a body and a cover, and the brace may be disposed between the outer race of the main bearing and the body.

In another aspect of the disclosure that may be combined with any of these aspects, the body may include an inner sleeve coupled to the outer race of the main bearing, and the brace may be disposed between the outer race of the main bearing and the inner sleeve of the body.

In another aspect of the disclosure that may be combined with any of these aspects, the brace may comprise a retaining ring.

In another aspect of the disclosure that may be combined with any of these aspects, the outer race may include an exterior bearing surface defining a groove, the output coupling may include an interior bearing surface defining a channel, and the retaining ring may include an inner portion disposed in the groove and an outer portion disposed in the channel.

In another aspect of the disclosure that may be combined with any of these aspects, a quantity of viscous fluid is contained in the fluid operating chamber, and a relative amount of the quantity of viscous fluid within the fluid operating chamber controls a torque engagement of the output coupling at a given rotational speed of the input coupling.

In another aspect of the disclosure that may be combined with any of these aspects, the engine cooling system may be mounted on a frame supported for rotation relative to a ground engaging transport structure, and changes in a rotational direction of the frame impart changes in an angular momentum vector of the clutch plate.

In another aspect of the disclosure that may be combined with any of these aspects, angular momentum vector changes urge the clutch plate into precession, and the brace engages the outer race to prevent movement of the main bearing along the driveshaft resulting from clutch plate precession.

In another aspect of the disclosure that may be combined with any of these aspects, the input coupling may comprise a plate defining an exterior surface, and recesses are formed in the exterior surface of the plate.

In another aspect of the disclosure that may be combined with any of these aspects, a machine may include a ground engaging transport structure, a frame coupled to the ground engaging transport structure and supported for rotation relative to the ground engaging transport structure, and an engine cooling system mounted on the frame. The engine cooling system includes a viscous fan drive having an output coupling including a body, a cover coupled to the body at an outer periphery, wherein the body and cover defining a fluid operating chamber. An input coupling includes a clutch plate disposed in the fluid operating chamber, the clutch plate defining an exterior surface formed with recesses, the clutch plate having an angular momentum vector which varies in response to changes in a rotational direction of the frame, thereby causing clutch plate precession. A driveshaft is coupled to the input coupling and defines a driveshaft axis. A main bearing has an inner race coupled to the driveshaft and an outer race coupled to the output coupling, the main bearing defining a bearing axis, wherein the bearing axis is normally substantially coincident with the shaft axis. A brace is disposed between the outer race of the main bearing and the output coupling.

In another aspect of the disclosure that may be combined with any of these aspects, the brace may be disposed between the outer race of the main bearing and the body.

In another aspect of the disclosure that may be combined with any of these aspects, the body may include an inner sleeve configured to closely receive the outer race of the main bearing, and the brace may be disposed between the outer race of the main bearing and the inner sleeve of the body.

In another aspect of the disclosure that may be combined with any of these aspects, the brace may comprise a retaining ring.

In another aspect of the disclosure that may be combined with any of these aspects, the outer race may include an exterior bearing surface defining a groove, the body may include an interior bearing surface defining a channel, and the retaining ring may include an inner portion disposed in the groove and an outer portion disposed in the channel.

In another aspect of the disclosure that may be combined with any of these aspects, a method of preventing main bearing movement along a driveshaft in a viscous fan drive includes providing a machine having a ground engaging transport structure, a frame coupled and rotatable relative to the ground engaging transport structure, and an engine cooling system mounted on the frame. The engine cooling system includes a viscous fan drive having an output coupling defining a fluid operating chamber, an input coupling including a clutch plate disposed in the fluid operating chamber, a driveshaft coupled to the input coupling and defining a driveshaft axis, and a main bearing having an inner race coupled to the driveshaft and an outer race coupled to the output coupling, the main bearing defining a bearing axis normally coincident with the driveshaft axis. The driveshaft is rotated about the driveshaft axis so that the clutch plate rotates, thereby to impart an angular momentum vector in the clutch plate. A rotational direction of the frame is varied so that the angular momentum vector of the clutch plate changes, thereby inducing precession of the clutch plate. The main bearing is secured to the output coupling to prevent movement of the main bearing along the driveshaft.

In another aspect of the disclosure that may be combined with any of these aspects, securing the main bearing may comprise providing a brace disposed between the outer race of the main bearing and the output coupling.

In another aspect of the disclosure that may be combined with any of these aspects, the output coupling may comprise a body and a cover, the body may include an inner sleeve configured to closely receive the outer race of the main bearing, and the brace may be disposed between the outer race of the main bearing and the inner sleeve of the body.

In another aspect of the disclosure that may be combined with any of these aspects, the brace may comprise a retaining ring.

In another aspect of the disclosure that may be combined with any of these aspects, the outer race may include an exterior bearing surface defining a groove, the output coupling may include an interior bearing surface defining a channel, and the retaining ring may include an inner portion disposed in the groove and an outer portion disposed in the channel.

In another aspect of the disclosure that may be combined with any of these aspects, the output coupling may comprise a body joined to a cover.

### BRIEF DESCRIPTION OF THE DRAWINGS

FIG. 1 is a perspective view of a hydraulic excavator incorporating a cooling system having a fan drive according to the present disclosure.

FIG. 2 is a schematic side elevation view of the cooling system of FIG. 1.

FIG. 3 is a schematic side elevation view, in cross-section, of a viscous fan drive used in the cooling system of FIG. 2.

FIG. 4 is a plan view of an exemplary brace used in the viscous fan drive of FIG. 3.

FIG. 5 is a schematic perspective view, in partial cross-section, of a main bearing used in the viscous fan drive of FIG. 3.

### DETAILED DESCRIPTION

Exemplary embodiments of a viscous fan drive are disclosed that reduce the undesirable results of clutch plate precession by securing a main bearing from moving along a driveshaft. Generally, precession is a change in the orientation of the rotational axis of a rotating body. In a viscous fan drive, many factors may contribute to changes in the angular momentum vector of the rotating clutch plate, thereby causing gyroscopic precession. For example, changes in rotational speed of the clutch plate or the magnitude of torque transfer in the viscous fan drive may alter the angular momentum vector of the clutch plate. In some applications, the angular momentum vector may be significantly affected by operation of the machine in which the viscous fan drive is used. In a hydraulic excavator, for example, the viscous fan drive is mounted on a frame that can rotate relative to ground engaging transport structures, such as tracks or wheels. Changes in rotational direction of the frame may also cause the angular momentum vector of the clutch plate to also change, thereby inducing precession. Precession of the clutch plate exerts a wobbling force on the main bearing, which results in forces that tend to undesirably move the main bearing along the driveshaft and potentially out of the fan drive housing. According to this disclosure, a brace is provided to reduce or eliminate precession of the clutch plate and fix the position of the main bearing on the driveshaft.

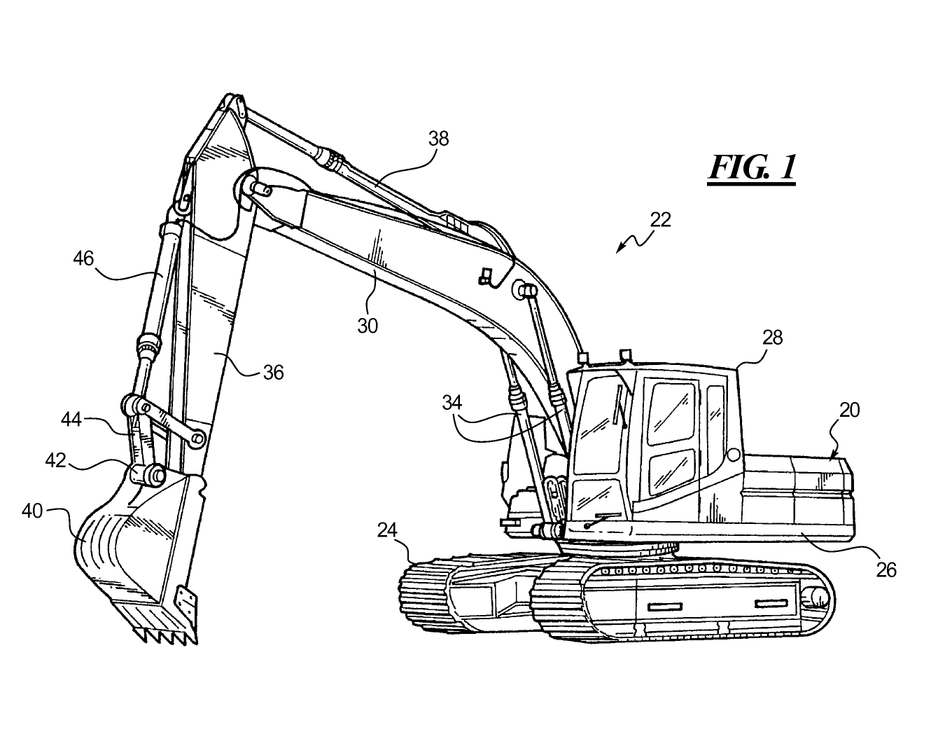

An exemplary machine is illustrated in FIG. 1 that incorporates an engine cooling system 20 according to the present disclosure. In the illustrated embodiment, the machine is depicted as a hydraulic excavator 22 having ground engaging tracks 24 and a frame 26 supporting an operator cab 28. In the illustrated embodiment, the frame 26 is supported for rotation about a vertical axis relative to the tracks 24. A boom 30 is pivotally attached to the frame 26, and is also pivotally attached to a hydraulic actuator having a pair of hydraulic cylinders 34. In similar fashion, an arm 36 is pivotally attached to the end of the boom 30, and another hydraulic cylinder 38 is operably coupled between the boom 30 and the arm 36. An excavator bucket 40 is mounted on a coupling 42 which is attached to a bucket linkage 44 that is pivotally secured to the end of the arm 36. Yet another hydraulic actuator 46 is operably coupled between the arm 36 and the bucket linkage 44 to actuate the bucket 40. The excavator 22 is merely an exemplary type of machine that may use the cooling system 20 of the present disclosure, as any machine requiring engine cooling may benefit from the advantages disclosed herein.

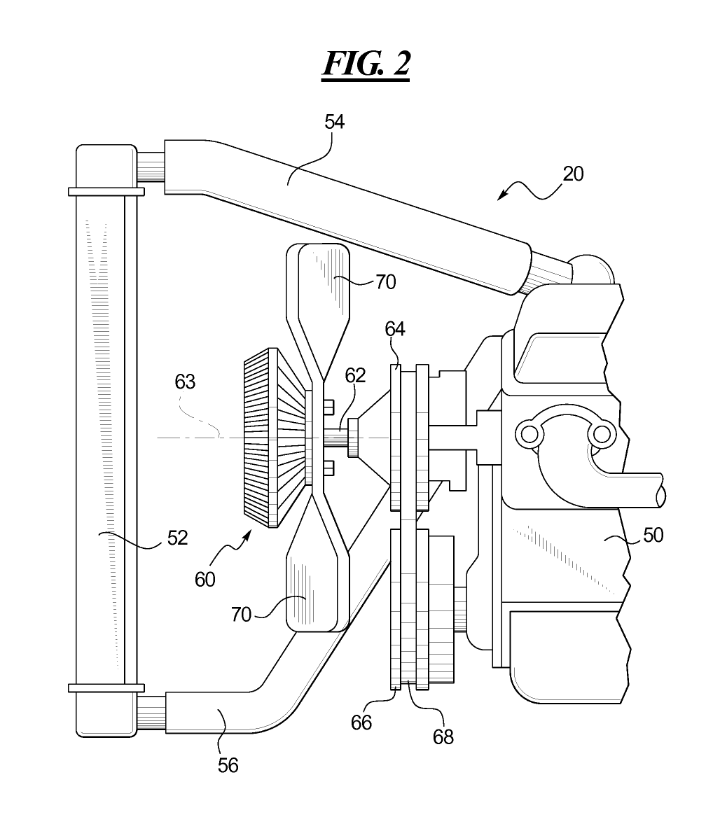

Referring now to FIG. 2, the cooling system 20 is shown in greater detail. The cooling system 20 includes an engine 50 and a radiator 52 interconnected by hoses 54 and 56. Thus, fluid coolant can flow from the engine 50 through the hose 54, then through the radiator 52, and return through the hose 56 to the engine 50.

The cooling system 70 includes a viscous fan drive 60 having a driveshaft 62 supported for rotation about a driveshaft axis 63. The driveshaft 62 may be driven in any suitable manner, such as by mechanical connection to the crankshaft of the engine 50. In the illustrated embodiment, the connection is indirect, wherein the driveshaft 62 is driven by a pair of pulleys 64, 66 and a V-belt 68. Alternatively, the connection may be direct, wherein the driveshaft 62 is substantially an extension of the crankshaft (not shown). Bolted to the rearward side of the viscous coupling 60 is a radiator cooling fan 70, including a plurality of fan blades.

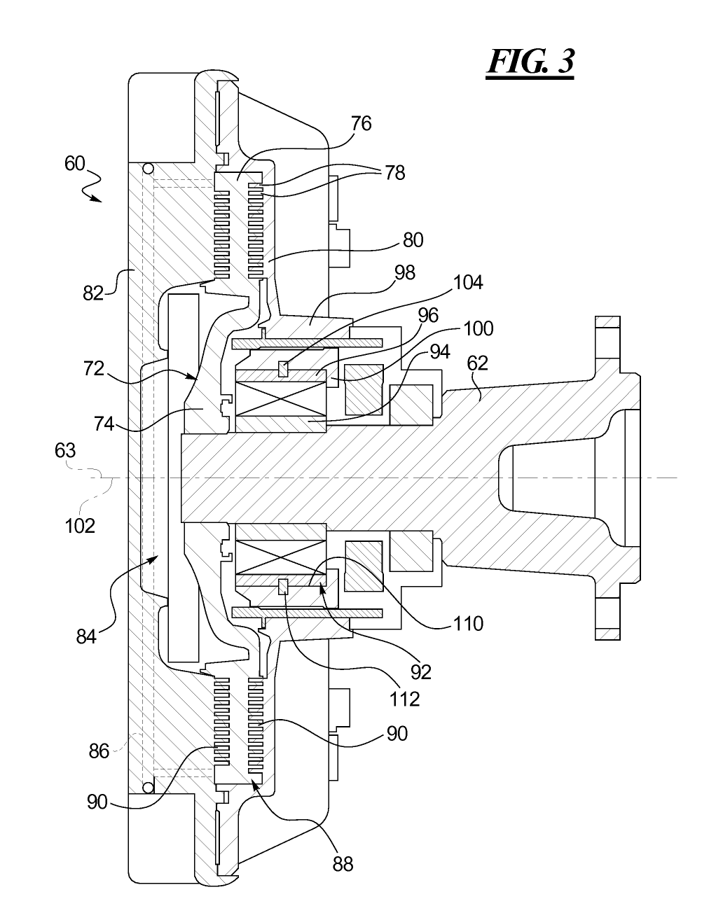

The viscous fan drive 60 includes a viscous coupling that uses a viscous fluid to transmit a variable amount of torque from an input coupling to an output coupling. As best shown in FIG. 3, the input coupling may be a clutch plate 72 having a central hub 74 coupled to the driveshaft 62. Accordingly, the clutch plate 72 is supported by and rotates with the driveshaft 62. The clutch plate 72 also includes a clutch disc 76 extending outwardly from the central hub 74. An exterior surface of the clutch disc 76 may be formed with a series of recesses 78.

The output coupling may include a body 80 and a cover 82 that are joined at outer peripheries to define an internal chamber 84. The internal chamber 84 may include a fluid reservoir chamber 86 that selectively communicates with a fluid operating chamber 88. In the illustrated embodiment, the fluid operating chamber 88 is formed between portions of the body 80 and cover 82 that are configured to receive the clutch disc 76. Accordingly, the portions of the body 80 and cover 82 forming the fluid operating chamber 88 may have projections 90 sized for insertion into the recesses 78 of the clutch disc 76.

A quantity of viscous fluid is contained in the fluid operating chamber 88 to transfer torque from the input coupling to the output coupling. The quantity of viscous fluid in the fluid operating chamber 88 may be varied to control the torque engagement of the output coupling at a given rotational speed of the input coupling. For example, viscous fluid may be delivered from the fluid reservoir chamber 86 into the fluid operating chamber 88 to increase the amount of torque transfer at a given rotational speed of the clutch plate 72. Conversely, viscous fluid may be removed from the fluid operating chamber 88 to the fluid reservoir chamber 86 to decrease the amount of torque transfer.

A main bearing 92 is provided to permit relative rotation between the input coupling and the output coupling. As best shown in FIG. 3, the main bearing 92 includes an inner race 94 coupled to the driveshaft 62 and an outer race 96 coupled to the output coupling. Specifically, the body 80 of the output coupling includes an inner sleeve 98 that is sized to closely receive the outer race 96 of the main bearing 92. The body 80 may further include a bearing seat 100 that extends inwardly from the inner sleeve 98 to limit insertion of the outer race 96 into the inner sleeve 98. The main bearing 92 is oriented along a bearing axis 102 that is normally substantially coincident with the driveshaft axis 63.

A brace is disposed between the outer race 96 of the main bearing 92 and the output coupling to prevent precession of the clutch plate 72. During operation of the viscous fan drive 60, the clutch plate 72 may be operated at different rotational speeds and with varying amounts of viscous fluid in the fluid operating chamber 88. As these parameters change, and as the direction of rotation of the frame 26 relative to the tracks 24 changes, the angular momentum vector of the clutch plate 72 may also change. These variations in the angular momentum can cause precession of the clutch plate 72 which, in turn, may exert a wobbling force on the main bearing 92 and result in the main bearing 92 undesirably moving along the driveshaft 62. To reduce or eliminate precession of the clutch plate 72, the brace is provided to positively fix the position of the main bearing 92 relative to the output coupling.

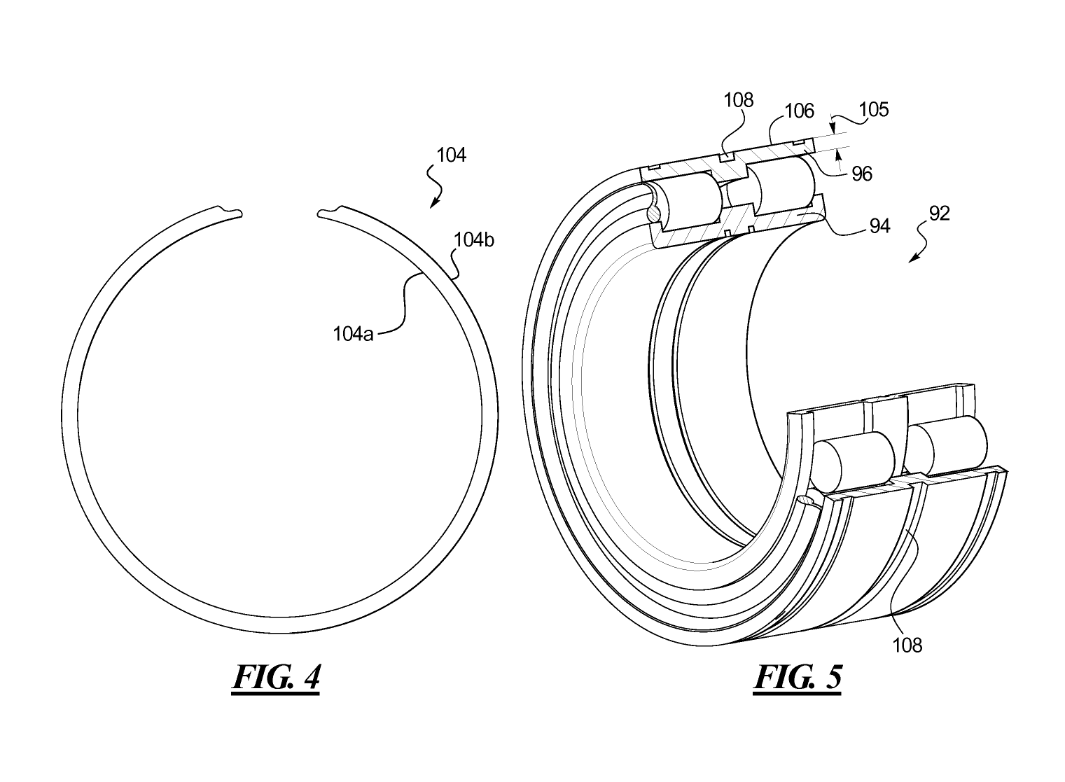

In the illustrated embodiment, the brace is provided as a retaining ring 104. As best shown in FIG. 5, the outer race 96 of the main bearing 92 has a thickness 105. An exterior surface 106 of the outer race 96 is formed with a groove 108 that extends partially into the thickness 105 of the outer race 96. Referring to FIG. 3, the inner sleeve 98 of the body 80 has an interior bearing surface 110 formed with a channel 112. The retaining ring 104 includes an inner portion 104a configured for insertion into the groove 108 and an outer portion 104b configured for insertion into the channel 112. As shown in FIG. 4, in at least one embodiment the retaining ring 104 may extend only partially around a periphery of the outer race 96. Alternative embodiments include configurations wherein the retaining ring 104 is configured to extend substantially entirely around the periphery of the outer race 96 after insertion into the groove 108 or channel 112. The retaining ring may be formed of a suitably rigid material, such as hardened steel or other materials with similar characteristics. The retaining ring 104 is sized to closely fit the groove 108 and channel 112 to reduce the effects of clutch plate precession.

### INDUSTRIAL APPLICABILITY

The present disclosure is applicable to machines having engine cooling systems using viscous fan drives. More specifically, the present disclosure reduces or prevents precession of a clutch plate 72 in a viscous fan drive 60 by securing a main bearing 92 to an output coupling. A retaining ring 104 is provided to reduce the effects of clutch plate precession, which tend to move the main bearing 92 along the driveshaft 62.

More specifically, during operation of the viscous fan drive 60, the driveshaft 62 rotates the clutch plate 72 within the operating chamber 88. The inner race 94 of the main bearing 92 also rotates with the driveshaft 62. The outer race 96 is coupled to the body 80 of the output coupling, so that the main bearing 92 permits rotation of the driveshaft 62 and clutch plate 72 relative to the body 80 and cover 82 of the output coupling. As conditions change to vary the angular momentum vector of the clutch plate 72, the clutch plate 72 is urged into precession. The wobbling forces generated by clutch plate precession are transferred to the main bearing 92. While the inner race 94 may conventionally be retained in fixed relation to the driveshaft 62, the outer race 96 typically is not. Accordingly, the groove 108 is formed in the exterior surface 106 of the outer race 96 and the channel 112 is formed in the interior bearing surface 110 of the inner sleeve 98. The retaining ring inner portion 104a is disposed in the groove 108 and the retaining ring outer portion 104b is disposed in the channel 112. Precession of the clutch plate 72 urges the outer race 96 to move axially relative to the inner sleeve 98, thereby potentially shifting the main bearing 92 along the drive shaft 62. Each side wall of the retaining ring 104 engages respective side walls of both the groove 108 and channel 112, thereby to prevent axial movement of the outer race 96 relative to the inner sleeve 98.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A viscous fan drive for an engine cooling system, comprising:
an output coupling defining a fluid operating chamber;
an input coupling disposed in the fluid operating chamber;
a driveshaft coupled to the input coupling and defining a driveshaft axis;
a main bearing having an inner race coupled to the driveshaft and an outer race coupled to the output coupling, the main bearing defining a bearing axis, wherein the bearing axis is normally substantially coincident with the driveshaft axis;
a brace disposed between the outer race of the main bearing and the output coupling.

2. The viscous fan drive of claim 1, in which the output coupling comprises a body and a cover, and in which the brace is disposed between the outer race of the main bearing and the body.

3. The viscous fan drive of claim 2, in which the body includes an inner sleeve coupled to the outer race of the main bearing, and in which the brace is disposed between the outer race of the main bearing and the inner sleeve of the body.

4. The viscous fan drive of claim 1, in which the brace comprises a retaining ring.

5. The viscous fan drive of claim 4, in which the outer race includes an exterior bearing surface defining a groove, the output coupling includes an interior bearing surface defining a channel, and the retaining ring includes an inner portion disposed in the groove and an outer portion disposed in the channel.

6. The viscous fan drive of claim 1, in which a quantity of viscous fluid is contained in the fluid operating chamber, wherein a relative amount of the quantity of viscous fluid within the fluid operating chamber controls a torque engagement of the output coupling at a given rotational speed of the input coupling.

7. The viscous fan drive of claim 1, in which the engine cooling system is mounted on a frame supported for rotation relative to a ground engaging transport structure, and in which changes in a rotational direction of the frame impart changes in an angular momentum vector of the clutch plate.

8. The viscous fan drive of claim 7, in which angular momentum vector changes urge the clutch plate into precession, and in which the brace engages the outer race to prevent movement of the main bearing along the driveshaft resulting from clutch plate precession.

9. The viscous fan drive of claim 1, in which the input coupling comprises a plate defining an exterior surface, and in which recesses are formed in the exterior surface of the plate.

10. A machine, comprising:
a ground engaging transport structure;
a frame coupled to the ground engaging transport structure and supported for rotation relative to the ground engaging transport structure; and
an engine cooling system mounted on the frame, the engine cooling system including a viscous fan drive having:
an output coupling including a body, a cover coupled to the body at an outer periphery, the body and cover defining a fluid operating chamber;
an input coupling including a clutch plate disposed in the fluid operating chamber, the clutch plate defining an exterior surface formed with recesses, the clutch plate having an angular momentum vector which varies in response to changes in a rotational direction of the frame, thereby causing clutch plate precession;
a driveshaft coupled to the input coupling and defining a driveshaft axis;
a main bearing having an inner race coupled to the driveshaft and an outer race coupled to the output coupling, the main bearing defining a bearing axis, wherein the bearing axis is normally substantially coincident with the shaft axis; and
a brace disposed between the outer race of the main bearing and the output coupling.

11. The machine of claim 10, in which the brace is disposed between the outer race of the main bearing and the body.

12. The machine of claim 10, in which the body includes an inner sleeve configured to closely receive the outer race of the main bearing, and in which the brace is disposed between the outer race of the main bearing and the inner sleeve of the body.

13. The machine of claim 10, in which the brace comprises a retaining ring.

14. The machine of claim 13, in which the outer race includes an exterior bearing surface defining a groove, the body includes an interior bearing surface defining a channel, and the retaining ring includes an inner portion disposed in the groove and an outer portion disposed in the channel.

15. A method of preventing main bearing movement along a driveshaft in a viscous fan drive, the method comprising:
providing a machine having a ground engaging transport structure, a frame coupled and rotatable relative to the ground engaging transport structure, and an engine cooling system mounted on the frame, the engine cooling system including a viscous fan drive having
an output coupling defining a fluid operating chamber;
an input coupling including a clutch plate disposed in the fluid operating chamber;
a driveshaft coupled to the input coupling and defining a driveshaft axis; and
a main bearing having an inner race coupled to the driveshaft and an outer race coupled to the output coupling, the main bearing defining a bearing axis normally coincident with the driveshaft axis
rotating the driveshaft about the driveshaft axis so that the clutch plate rotates, thereby to impart an angular momentum vector in the clutch plate;
varying a rotational direction of the frame so that the angular momentum vector of the clutch plate changes, thereby inducing precession of the clutch plate; and
securing the main bearing to the output coupling to prevent movement of the main bearing along the driveshaft.

16. The method of claim 15, in which securing the main bearing comprises providing a brace disposed between the outer race of the main bearing and the output coupling.

17. The method of claim 16, in which the output coupling comprises a body and a cover, the body including an inner sleeve configured to closely receive the outer race of the main bearing, and in which the brace is disposed between the outer race of the main bearing and the inner sleeve of the body.

18. The method of claim 17, in which the brace comprises a retaining ring.

19. The method of claim 18, in which the outer race includes an exterior bearing surface defining a groove, the output coupling includes an interior bearing surface defining a channel, and the retaining ring includes an inner portion disposed in the groove and an outer portion disposed in the channel.

20. The method of claim 15, in which the output coupling comprises a body joined to a cover.
